(19) United States
(12) Patent Application Publication
(10) Pub. No.: US 2007/0229735 A1
(43) Pub. Date: Oct. 4, 2007

(54) METHOD FOR MANUFACTURING LIQUID CRYSTAL DISPLAY AND LIQUID CRYSTAL DISPLAY MANUFACTURED THEREBY

(75) Inventors: Dong-Chin LEE, Cheonan-si (KR); Myung-Il Park, Daejeon (KR); Kyung-Seop Kim, Suwon-si (KR); Yong-Eui Lee, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD, Suwon-si (KR)

(21) Appl. No.: 11/553,167

(22) Filed: Oct. 26, 2006

(30) Foreign Application Priority Data
Mar. 29, 2006 (KR) 10-2006-0028498

(51) Int. Cl. G02F 1/1335

(52) U.S. Cl. 349/106

(57) ABSTRACT

A liquid crystal display (LCD) manufactured by a manufacturing method thereof may reduce a processing time by reducing the number of processing steps. The method for manufacturing an LCD includes forming red, green and blue color filters corresponding to pixels on a substrate, and forming black matrix patterns by irradiating a laser beam onto boundary portions of the red, green and blue color filters.

### CROSS REFERENCE TO RELATED APPLICATION

This application claims the benefit of and priority to Korean Patent Application No. 10-2006-0028498 filed on Mar. 29, 2006, which is hereby incorporated by reference for all purposes as if fully set forth herein.

### BACKGROUND OF THE INVENTION

1. Field of the Invention

The present invention relates to a method for manufacturing a liquid crystal display (LCD) and an LCD manufactured by the method, and more particularly to an LCD manufacturing method that can reduce a processing time by reducing the number of processing steps, and an LCD manufactured by the method.

2. Discussion of the Background

Liquid crystal displays (LCDs) have become popular as a flat panel display type that may replace cathode ray tube displays.

The LCD has liquid crystals in a liquid crystal layer arranged between two transparent electrodes formed on substrates. The liquid crystals align into different orientations depending on the relative voltages of the electrodes. When the orientations of the liquid crystals change, the refractive index for light passing through the liquid crystal layer also changes. Therefore, the LCD displays images by controlling the amount of light that passes through the liquid crystal layer.

The LCD may include a thin film transistor (TFT) substrate having a plurality of gate lines and a plurality of data lines, a switching device formed at an intersection of a gate line and a data line, and a pixel electrode coupled with the switching device. The LCD may also include a color filter substrate facing and coupled with the TFT substrate. The color filter substrate may have a red color filter, a green color filter, a blue color filter, and a common electrode corresponding to a plurality of pixel electrodes. The LCD may also include a liquid crystal layer having liquid crystals and interposed between the TFT substrate and the color filter substrate.

The red color filter, the green color filter, and the blue color filter arranged on the color filter substrate have conventionally been formed using a photolithography process in which organic red, green, and blue photosensitive materials are coated on the color filter substrate and then selectively etched using etch masks.

In addition, black matrix patterns for optically isolating the red color filter, the green color filter, and the blue color filter from each other and absorbing irregularly reflected light are arranged on the color filter substrate. The black matrix patterns may be formed using a photolithography process in which an organic material is coated on the color filter substrate and then selectively etched using the etch mask.

In manufacturing the conventional color filter substrate, the black matrix patterns are first formed and the red color filter, the green color filter, and the blue color filter are then formed, requiring a large number of processing steps and an increase in processing time. In addition, since a photolithography processing chamber is additionally required for forming the black matrix patterns, the amount of manufacturing equipment increases, which also increases the manufacturing cost.

### SUMMARY OF THE INVENTION

This invention provides a method for manufacturing a liquid crystal display (LCD) with a reduced number of process steps, and an LCD manufactured by the method.

Additional features of the invention will be set forth in the description which follows, and in part will be apparent from the description, or may be learned by practice of the invention.

The present invention discloses a method for manufacturing an LCD including forming a red color filter, a green color filter, and a blue color filter each corresponding to pixels on a first insulating substrate, and forming black matrix patterns at boundary portions of the red color filter, the green color filter, and the blue color filter by irradiating a laser beam onto the boundary portions of the red color filter, the green color filter, and the blue color filter.

The present invention also discloses an LCD including a red color filter, a green color filter, and a blue color filter arranged on a first insulating substrate and each corresponding to a pixel region of the LCD, and black matrix patterns arranged between each color filter, the black matrix patterns formed by irradiating a laser beam onto boundary portions of the red color filter, the green color filter, and the blue color filter to cause variations to compositions of the red color filter, the green color filter, and the blue color filter.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an exploded perspective view of an LCD according to an exemplary embodiment of the present invention.

FIG. 2 shows a cross-sectional view of a color filter substrate of the LCD shown in FIG. 1.

FIG. 3 shows a schematic diagram of a laser beam generator for forming black matrix patterns shown on the color filter substrate of FIG. 2.

FIG. 4A, FIG. 4B, FIG. 4C, and FIG. 4D show cross-sectional views of process steps in a method for manufacturing a color filter substrate according to an exemplary embodiment of the present invention.

FIG. 5 shows a cross-sectional view of a method for manufacturing a color filter substrate according to a second exemplary embodiment of the present invention.

FIG. 6A, FIG. 6B, FIG. 6C, and FIG. 6D show cross-sectional views of process steps in a method for manufacturing a color filter substrate according to a third exemplary embodiment of the present invention.

FIG. 7 shows a cross-sectional view of a method for manufacturing a color filter substrate according to a fourth exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

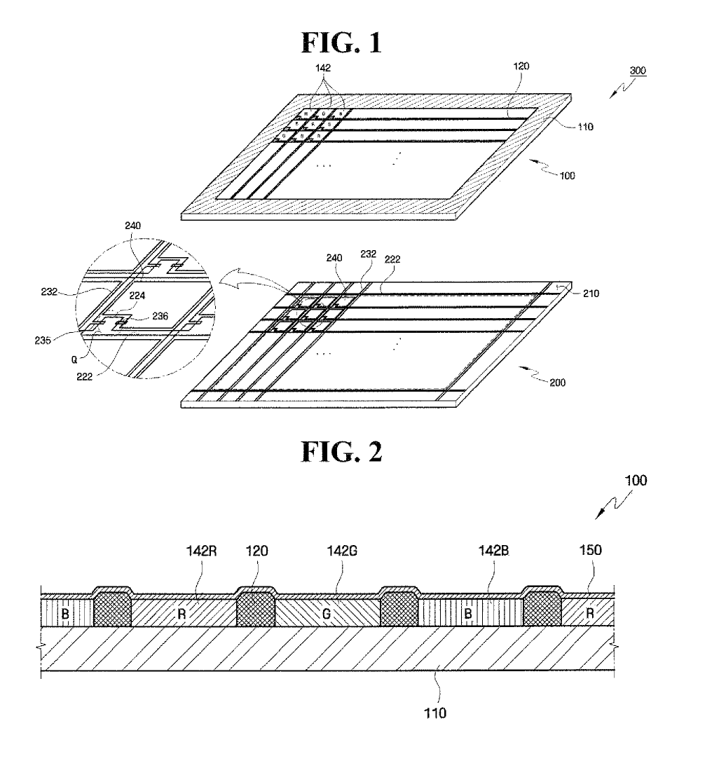

FIG. 1 shows an exploded perspective view of an LCD according to an exemplary embodiment of the present invention.

Referring to FIG. 1, a liquid crystal display 300 may include a color filter substrate 100, a thin film transistor (TFT) array substrate 200 facing and opposed to the color filter substrate 100 and a liquid crystal layer (not shown) with liquid crystals interposed therebetween.

The color filter substrate 100 may include a first insulating substrate 110 as a base substrate, black matrix patterns 120, and color filters 142 bordered by the black matrix patterns 120 and formed in a matrix shape to define pixel units. The color filters 142 may include, for example, a red color filter 142R, a green color filter 142G and a blue color filter 142B alternately arranged, and corresponding to and substantially covering pixel electrodes 240 of the TFT array substrate 200. The black matrix patterns 120 may be arranged to correspond to gate lines 222 and data lines 232 of the TFT array substrate 200 along boundary portions of the pixels.

TFT array substrate 200 may include a second insulating substrate 210 as a base substrate, and a plurality of TFTs arranged on the second insulating substrate 210. A single TFT may be disposed to correspond to a single pixel of the pixels arranged in a matrix shape. A control terminal of the TFT may be coupled with a gate electrode 224 protruding from a gate line 222 to be supplied with a gate signal. An input terminal of the TFT may be coupled with a source electrode 235 protruding from a data line 232 to be supplied with a data signal. An output terminal of the TFT may be coupled with a drain electrode 236 spaced apart from the source electrode 235. The drain electrode 236 may be coupled with a pixel electrode 240 substantially covering the pixel. When the TFT is turned on, the data signal is transmitted from the gate electrode 224, through the TFT to the pixel electrode 240.

The gate electrode 224 of each TFT may be formed as a single layer made of a metal such as aluminum (Al), aluminum alloy, copper (Cu), copper alloy, molybdenum (Mo), molybdenum alloy, chromium (Cr), tantalum (Ta), or titanium (Ti). In an alternative exemplary embodiment, the gate electrode 224 may be formed as a multi-layer electrode including a lower layer (not shown) made of a refractory metal, and a low-sensitivity upper layer (not shown). In addition, the source electrode 235 and the drain electrode 236 may be formed of a refractory metal such as chromium (Cr), a molybdenum alloy, tantalum (Ta), or titanium (Ti). In an alternative exemplary embodiment, the source electrode 235 and the drain electrode 236 may each be formed as a multi-layer electrode including a lower layer (not shown) made of a refractory metal, and a low-sensitivity upper layer (not shown).

The gate lines 222 coupled with the gate electrodes 224 may extend substantially parallel to each other between neighboring rows of pixel electrodes 240 in a first direction. The data lines 232 coupled with the source electrodes 235 may extend substantially parallel to each other between the neighboring columns of pixel electrodes 240 in a second direction. Gate lines 222 and data lines 232 may be electrically isolated from each other. TFTs may be arranged at regions where the gate lines 222 and the data lines 232 cross with each other.

A liquid crystal layer having dielectric anisotropy may be interposed between the color filter substrate 100 and the TFT array substrate 200, which may be coupled together by, for example, a sealant.

In the following description, a cross-sectional structure of a color filter substrate 100 as a substrate of the LCD will be described in greater detail with reference to FIG. 2. FIG. 2 shows a cross-sectional view of a color filter substrate 100 of the LCD shown in FIG. 1.

As shown in FIG. 2, the color filter substrate 100 may have an insulating substrate 110 as a base substrate. The insulating substrate 110 may be transparent and formed of transparent glass, transparent plastic, or a transparent synthetic resin plate, but the present invention is not limited thereto.

A red color filter 142R, a green color filter 142G and a blue color filter 142B may be positioned on the insulating substrate 110. The red color filter 142R may contain red pigments and a resin. The green color filter 142G may contain green pigments and a resin. The blue color filter 142B may contain blue pigments and a resin. Usable examples of the resin may include an organic material such as casein, gelatin, polyvinyl alcohol carboxymethyl acetal, polyimide resin, acryl resin, or melanin resin, but the present invention is not limited thereto.

The black matrix patterns 120 may be positioned at boundary portions of the red color filter 142R, the green color filter 142G, and the blue color filter 142B. The black matrix patterns 120 may shield back light or external light, and may optically isolate the red color filter 142R, the green color filter 142G and the blue color filter 142B from each other. The black matrix patterns 120 may be formed by irradiating laser beams onto the boundary portions of the red color filter 142R, the green color filter 142G and the blue color filter 142B to cause variations to compositions of the red color filter 142R, the green color filter 142G, and the blue color filter 142B. The black matrix patterns 120 may have substantially the same width as the gate lines and data lines formed on the TFT array substrate 200. For example, the black matrix patterns 120 may have a width in a range of about 10 μm to about 40 μm.

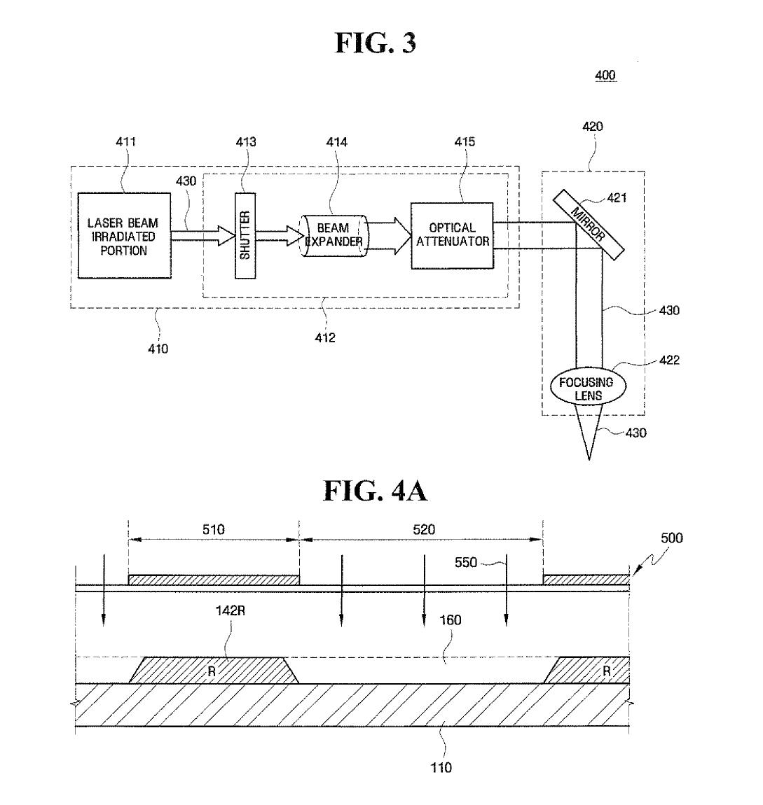

FIG. 3 shows a schematic diagram of a laser beam generator 400 for forming the black matrix patterns 120 shown on the color filter substrate of FIG. 2.

Referring to FIG. 3, the laser beam generator 400 may include a laser beam generating unit 410 and a laser beam focusing unit 420.

The laser beam generating unit 410 may include a laser beam irradiated portion 411 for generating a laser beam 430 and a laser beam transmitting portion 412 for transmitting a laser beam 430.

The laser beam transmitting portion 412 may include a shutter 413 for increasing the intensity and efficiency of the laser beam 430, a beam expander 414 for expanding the width of the laser beam 430, and an optical attenuator 415 for adjusting the energy of the laser beam 430.

The shutter 413 may increase the intensity and efficiency of the laser beam 430 by shielding the laser beam 430 along edge portions, thereby increasing the laser beam 430 intensity in a central portion of a cross-section of the laser beam 430 irradiated from the irradiated portion 411. The shutter 413 may be installed either before or after the beam expander 414. In the exemplary embodiment shown in FIG. 3, however, the shutter 413 is shown installed before the beam expander 414 by way of example.

The beam expander 414 may expand the width of the laser beam 430 passing through the shutter 413. Specifically, the beam expander 414 may increase an outer diameter of the laser beam 430 to prevent an optical system from being damaged due to the energy of the laser beam 430 and to extend the life expectancy of the laser beam generator 400. A width expansion ratio of the laser beam 430 passing through the beam expander 414 can be adjusted by a motor (not shown) controlled by a predetermined controller (not shown).

The optical attenuator 415 may vary the energy of the laser beam 430. In an exemplary embodiment, the optical attenuator 415 may be formed in a circular disk shape, and may attenuate the laser beam 430 as the optical attenuator 415 rotates. Alternatively, in order to attenuate the intensity of the laser beam 430, the optical attenuator 415 may include a rotating device driven by a motor, the rotating device including, for example, a λ/2 plate, a linear polarizer, and a λ/4 plate.

A laser beam focusing unit 420 may include a mirror 421 for changing a traveling direction of the laser beam 430 passing out of the laser beam generating unit 410, and a focusing lens 422 for focusing the laser beam 430 to a device (not shown) to be irradiated by the laser beam 430.

The mirror 421 may change a traveling direction of the laser beam 430 passing out of the laser beam transmitting portion 412. The mirror 421 may operate to transmit only a portion of the laser beam 430 with a predetermined wavelength by applying a material to a surface of the mirror 421. Alternatively, the mirror 421 may have pin holes formed thereon to limit the transmission of the laser beam 430.

The focusing lens 422 may include a plurality of lenses for focusing the laser beam 430 transmitted from the mirror 421 onto the device to be irradiated by the laser beam 430, and may perform a focusing operation while moving up and down while controlled by a controller (not shown).

The laser beam 430 may be irradiated onto the red color filter 142R, the green color filter 142G and the blue color filter 142B using the aforementioned laser beam generator 400, thereby changing the red color filter 142R, the green color filter 142G and the blue color filter 142B, to form the black matrix patterns 120.

The laser beam generator 400 may be, but is not limited to, a yttrium-aluminum-garnet (YAG) laser beam generator, a femto-second laser beam generator, or an excimer laser beam generator.

Referring back to FIG. 2, the common electrode 150 may be arranged over the black matrix patterns 120 and the red color filter 142R, the green color filter 142G and the blue color filter 142B. The common electrode 150 may be formed of at least a transparent conductive material such as Indium Tin Oxide (ITO) or Indium Zinc Oxide (IZO).

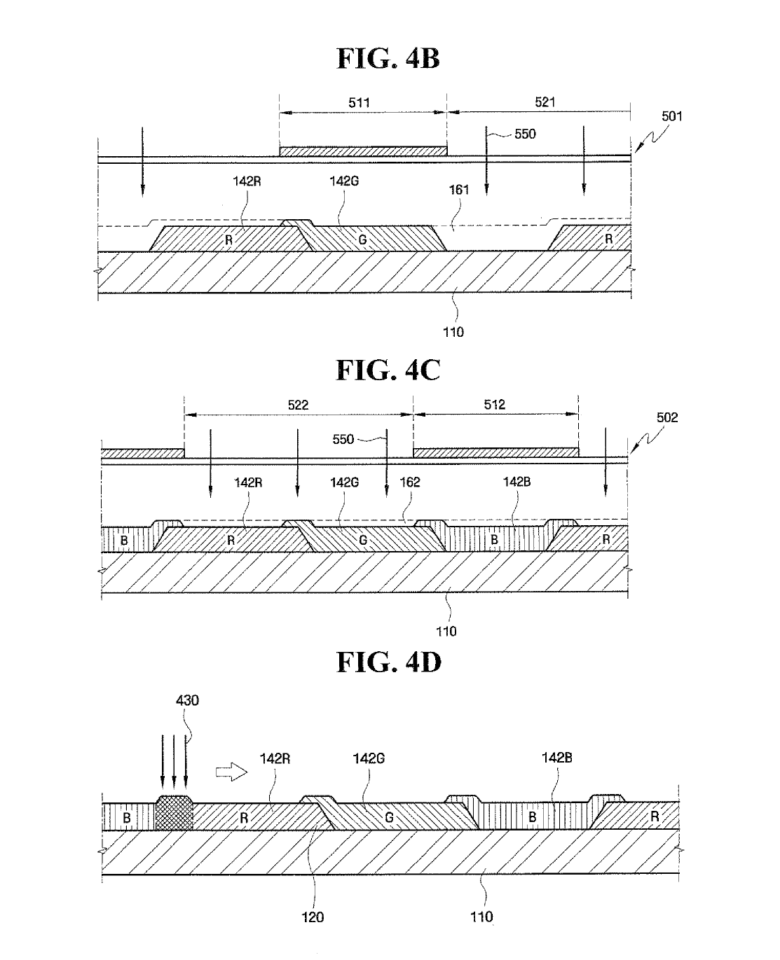

A method for manufacturing the color filter substrate of the LCD according to an exemplary embodiment of the present invention will now be described in detail with reference to FIG. 2 and FIG. 4A, FIG. 4B, FIG. 4C, and FIG. 4D. FIG. 4A, FIG. 4B, FIG. 4C, and FIG. 4D show cross-sectional views of process steps in a method for manufacturing a color filter substrate according to an exemplary embodiment of the present invention.

First, referring to FIG. 4A, FIG. 4B, and FIG. 4C, the red color filter 142R, the green color filter 142G and the blue color filter 142B each corresponding to pixels may be sequentially formed on an insulating substrate 110. Here, the red color filter 142R may comprise organic photosensitive resin 160 having red pigments dispersed therein. The green color filter 142G may comprise organic photosensitive resin 161 having green pigments dispersed therein. The blue color filter 142B may comprise organic photosensitive resin 162 having blue pigments dispersed therein. The organic photosensitive resins 160, 161 and 162 may comprise a photo-polymerizable composition including a photoinitiator, a monomer, and a binder, and organic pigments. In addition, the organic photosensitive resins 160, 161 and 162 may be coated by a printing method, a dying method, a pigment dispersion method, or another suitable coating method.

In more detail, as shown in FIG. 4A, the red color filter 142R may be formed by substantially uniformly coating the organic red photosensitive resin 160 on the first insulating substrate 110 to a predetermined thickness. The thickness of the organic red photosensitive resin 160 coated on the first insulating substrate 110 may be selected for the purpose of controlling color purity of an LCD. For example, the thickness of the organic red photosensitive resin 160 coated on the first insulating substrate 110 may be about 1 μm to about 3 μm. Next, the coated organic red photosensitive resin 160 may be soft-baked at a predetermined temperature, selectively exposed using a photo mask 500, and developed using a developer, to thereby form the red color filter 142R.

The photo mask 500 may be divided into a transmissive area 520 and a non-transmissive area 510 to allow ultraviolet (UV) rays 550 to selectively transmit through the photo mask 500. The photo mask 500 may allow open areas, other than the area where the red color filter 142R is formed on the first insulating substrate 110, to be exposed to the UV rays 550 to then be removed by the developer.

Since the red color filter 142R may have positive photosensitivity, the red color filter 142R located corresponding to the transmissive area 520 of the photo mask 500 may removed by the developer while the red color filter 142R located corresponding to the non-transmissive area 510 is not removed. Alternatively, the red color filter 142R may have negative photosensitivity, and the transmissive area 520 of the photo mask 500 may be positioned to correspond to the area where the red color filter 142R is formed.

Next, as shown in FIG. 4B, the green color filter 142G may be formed by substantially uniformly coating the organic green photosensitive resin 161 onto the first insulating substrate 110 to a predetermined thickness so as to overlap the red color filter 142R by a predetermined width. Next, the coated organic green photosensitive resin 161 may be soft-baked and exposed using a photo mask 501.

The photo mask 501 may be divided into a transmissive area 521 and a non-transmissive area 511 to allow UV rays 550 to selectively transmit through the photo mask 501.

Since the green color filter 142G may have positive photosensitivity, the green color filter 142G may be positioned corresponding to a non-transmissive area 511 of the photo mask 501.

Next, as shown in FIG. 4C, the blue color filter 142B may be formed by substantially uniformly coating the organic blue photosensitive resin 162 onto the first insulating substrate 110 to a predetermined thickness so as to overlap the red color filter 142R and the green color filter 142G by a predetermined width. Next, the coated organic blue photosensitive resin 162 may be soft-baked and exposed using a photo mask 502.

The photo mask 502 may be divided into a transmissive area 522 and a non-transmissive area 512 to allow UV rays 550 to selectively transmit through the photo mask 502.

Since the blue color filter 142B may have positive photosensitivity, the blue color filter 142B may be positioned corresponding to a non-transmissive area 521 of the photo mask 502. In addition, while FIG. 4C has shown that the red color filter 142R, the green color filter 142G, and the blue color filter 142B are formed to substantially the same thickness, thicknesses thereof may be adjusted to control color purity of an LCD. In the exemplary embodiment shown in FIG. 4A, FIG. 4B, and FIG. 4C, the red color filter 142R is first formed by way of example. However, the formation order of color filters can be changed.

In such a manner, the red color filter 142R, the green color filter 142G, and the blue color filter 142B are formed on the first insulating substrate 110. Next, the laser beam 430 may be irradiated onto boundary portions of the red color filter 142R, the green color filter 142G, and the blue color filter 142B to form the black matrix patterns 120.

Referring to FIG. 4D, the black matrix patterns 120 having a predetermined width may be formed by irradiating the laser beam 430 onto the boundary portions of the red color filter 142R, the green color filter 142G, and the blue color filter 142B to cause variations in the compositions of the boundary portions of the red color filter 142R, the green color filter 142G, and the blue color filter 142B.

In more detail, the black matrix patterns 120 may be formed in at least the following manner. First, black matrix patterns 120 may be formed by irradiating the laser beam 430 while repeatedly moving a predetermined interval in a first direction extending along one side of the red color filter 142R, the green color filter 142G, and the blue color filter 142B, specifically, along transverse boundary portions of the neighboring red color filter 142R, the green color filter 142G, and the blue color filter 142B. The laser beam 430 is focused onto transverse boundary portions of the red color filter 142R, the green color filter 142G, and the blue color filter 142B to cause variations in the compositions of the transverse boundary portions of the red color filter 142R, the green color filter 142G, and the blue color filter 142B.

Second, black matrix patterns 120 may be formed by irradiating the laser beam 430 while repeatedly moving a predetermined interval in a second direction extending along a longitudinal boundary portion of the neighboring red color filter 142R, green color filter 142G, and blue color filter 142B. Similarly, the laser beam 430 is focused onto longitudinal boundary portions of the red color filter 142R, the green color filter 142G, and the blue color filter 142B to cause variations in the compositions of the longitudinal boundary portions of the red color filter 142R, the green color filter 142G, and the blue color filter 142B.

An irradiation time of the laser beam 430 applied onto boundary portions of the red color filter 142R, the green color filter 142G, and the blue color filter 142B may vary according to the kind of the laser beam used. For example, a YAG laser beam generator or a femto-second laser beam generator may be used as the laser beam generator 400.

Since the red color filter 142R, the green color filter 142G and the blue color filter 142B may be first formed on the first insulating substrate 110, and the black matrix patterns 120 are then formed using the laser beam 430, the method according to the exemplary embodiment of the present invention obviates the necessity for photolithography processing equipment to form the black matrix patterns 120, unlike in the prior art. Accordingly, the number of processing steps, the processing time, and the manufacturing time may be reduced, thereby reducing the manufacturing cost.

The width of a black matrix pattern 120 may be adjusted by controlling a spot size of the laser beam 430 irradiated onto the black matrix patterns 120. For example, the width of a black matrix pattern 120 may be adjusted to about 10 μm to about 40 μm. In addition, in order to optically isolate the red color filter 142R, the green color filter 142G, and the blue color filter 142B from each other, a black matrix pattern 120 may be formed thicker than the red color filter 142R, the green color filter 142G, and the blue color filter 142B. For example, the thickness of a black matrix pattern 120 may be controlled to about 1 μm to about 5 μm.

Next, referring back to FIG. 2, the common electrode 150 may be formed over the first insulating substrate 110 having the red color filter 142R, the green color filter 142G, the blue color filter 142B and the black matrix patterns 120.

The common electrode 150 may be formed of a transparent conductive material such as ITO or IZO.

Therefore, the color filter substrate may be used as a substrate for the manufacture of an LCD.

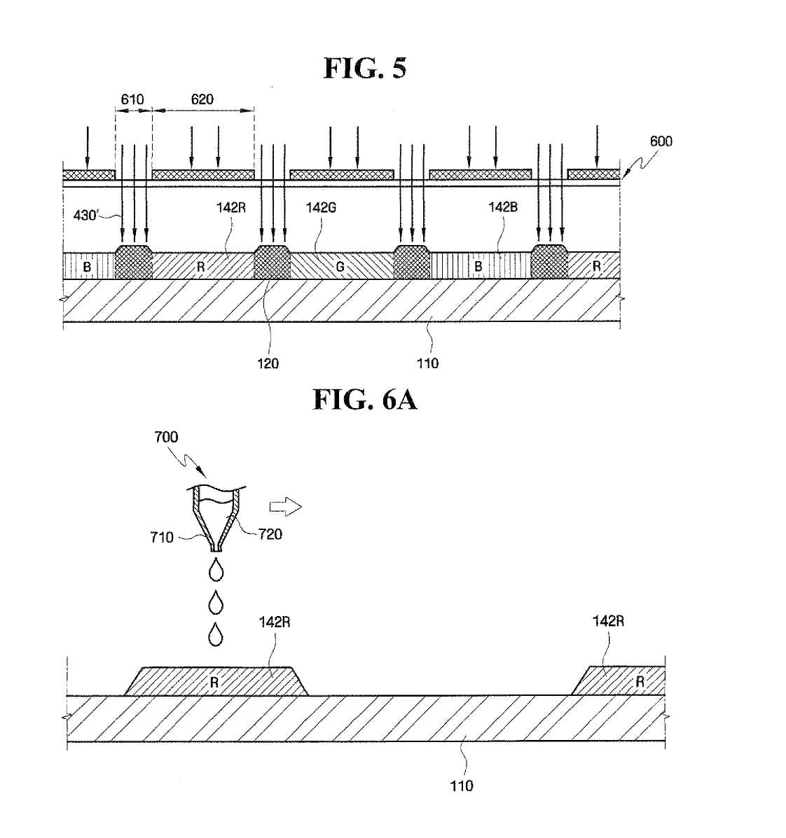

Next, a description will be given of a method for manufacturing a color filter substrate according to a second exemplary embodiment of the present invention with reference to FIG. 5. In FIG. 5, identical reference numerals refer to like or similar components as in previous figures. Therefore, a detailed description thereof will be omitted or briefly given. FIG. 5 shows a cross-sectional view of various processing steps in a method for manufacturing a color filter substrate according to a second exemplary embodiment of the present invention.

First, the red color filter 142R, the green color filter 142G, and the blue color filter 142B may be formed on the first insulating substrate 110 through the processes shown in FIG. 4A, FIG. 4B, and FIG. 4C. Then, referring to FIG. 5, the black matrix patterns 120 may be formed by irradiating a laser beam 430′ onto boundary portions of the red color filter 142R, the green color filter 142G, and the blue color filter 142B using a mask 600.

In more detail, the mask 600 having patterns exposing predetermined portions of boundaries of the red color filter 142R, the green color filter 142G, and the blue color filter 142B may be disposed over the red color filter 142R, the green color filter 142G, and the blue color filter 142B. The mask 600 may be divided into a transmissive area 610 and a non-transmissive area 620 to allow a laser beam 430′ to selectively transmit through the mask 600. Therefore, black matrix patterns 120 can be simultaneously formed on a plurality of boundaries of the red color filter 142R, the green color filter 142G, and the blue color filter 142B formed on the first insulating substrate 110.

In the present exemplary embodiment, the focus spot of the laser beam 430′ may be positioned over or under the red color filter 142R, the green color filter 142G, and the blue color filter 142B, to thereby simultaneously irradiate the laser beam 430′ over a relatively wide area.

Here, an irradiation time of the laser beam 430′ applied onto the red color filter 142R, the green color filter 142G, and the blue color filter 142B may vary according to the kind of laser beam used. An excimer laser beam generator, or a similar apparatus, may be used as the laser beam generator.

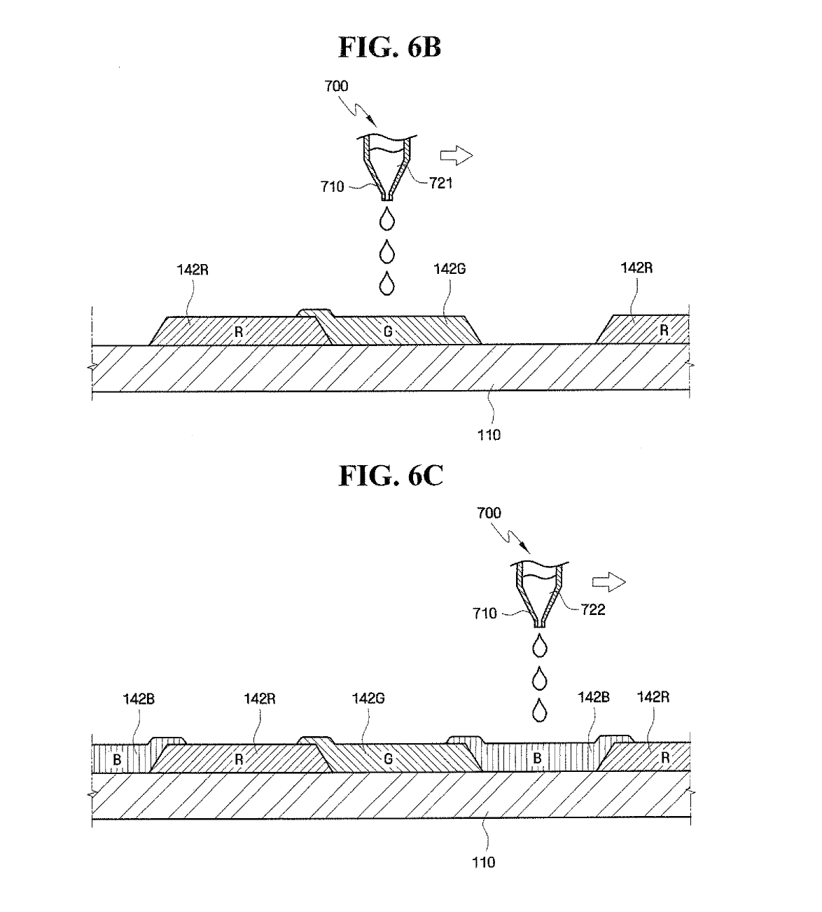

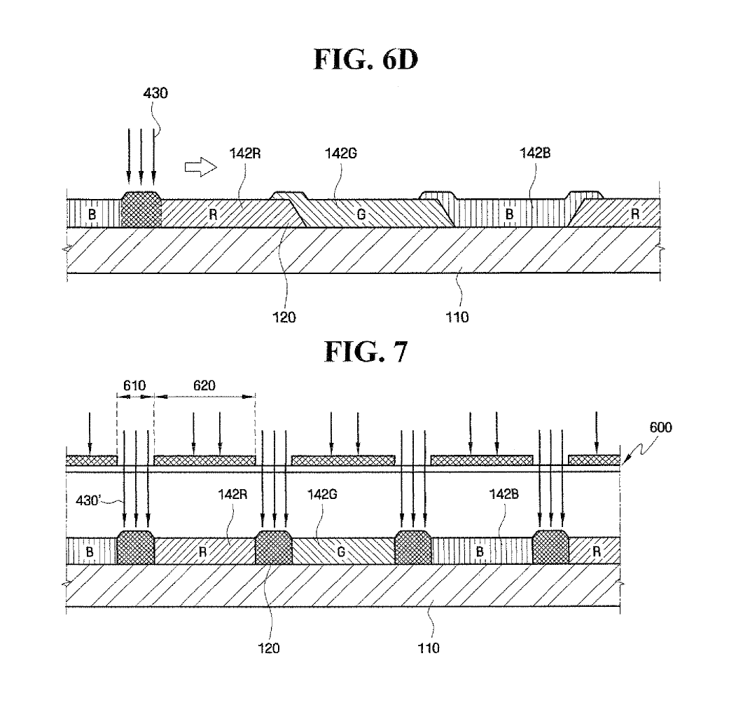

A method for manufacturing a color filter substrate according to a third exemplary embodiment of the present invention will be described in greater detail with reference to FIG. 2 and FIG. 6A, FIG. 6B, FIG. 6C, and FIG. 6D. FIG. 6A, FIG. 6B, FIG. 6C, and FIG. 6D show cross-sectional views of process steps in a method for manufacturing a color filter substrate according to a third exemplary embodiment of the present invention.

Referring to FIG. 6A, FIG. 6B, FIG. 6C, and FIG. 6D, the red color filter 142R, the green color filter 142G, and the blue color filter 142B may be formed on the first insulating substrate 110 using an inkjet head 700 by a printing method.

In more detail, as shown in FIG. 6A, the red color filter 142R may be formed by spraying ink 720 onto the first insulating substrate 110 through an inkjet nozzle 710 included in an inkjet head 700 while moving the inkjet head 700 in a predetermined direction. The ink 720 sprayed through the nozzle 710 may contain a red pigment and may have a predetermined viscosity to control the width of a color filter formed by the ink 720.

The ink 720 containing the red pigment may be selectively sprayed onto the first insulating substrate 110 to form patterns of the red color filter 142R. The spraying frequency of the ink 720 can be controlled by adjusting a voltage of the inkjet head 700. When the inkjet head 700 passes a first region of the first insulating substrate 110, the first region may be coated with the ink 720 through the nozzle 710 by vibrating the inkjet head 700. The first region may correspond to a region of a red color filter 142R. Then, vibration of the inkjet head 700 may be suspended while passing through a second region and a third region of the first insulating substrate 110. The second region may correspond to a region of a green color filter 142G, and the third region may correspond to a region of a blue color filter 142B. Next, when the inkjet head 700 reaches a fourth region corresponding to a region of a second red color filter 142R, the vibration of the inkjet head 700 may start again to apply the ink 720 onto the fourth region through the nozzle 710. The ink 720 for forming the red color filters 142R may be highly viscous so as to be applied only to a desired area of the first insulating substrate 110.

Although not shown in FIG. 6A, a plurality of nozzles 710 may be provided in the inkjet head 700 to simultaneously apply ink 720 for the red color filter 142R to multiple locations of the first insulating substrate 110 where a red color filter 142R is to be formed.

Next, as shown in FIG. 6B, the green color filter 142G may be formed by spraying ink 721 onto a second region of the first insulating substrate 110 exposed by the red color filter 142R by the same method as described above for the red color filter 142R while moving an inkjet head 700 having an inkjet nozzle 710 in a predetermined direction. To form the green color filter 142G, the ink 721 sprayed through the nozzle 710 may contain a green pigment, and may be highly viscous so as to be applied only on a desired area of the first insulating substrate 110. Here, a green color filter 142G may be adjacent to and overlap with a previously formed red color filter 142R by a predetermined width.

Finally, as shown in FIG. 6C, the blue color filter 142B may be formed by spraying ink 722 onto a third region of the first insulating substrate 110 exposed by the red and green color filters 142R and 142G by the same method as described above for the red color filter 142R and the green color filter 142G while moving the inkjet head 700 having the inkjet nozzle 710 in a predetermined direction. To form the blue color filter 142B, the ink 722 sprayed through the nozzle 710 may contain a blue pigment, and may be highly viscous so as to be applied only on a desired area of the first insulating substrate 110. Here, the blue color filter 142B may be adjacent to and overlap with a previously formed red color filter 142R or green color filter 142G by a predetermined width.

While FIG. 6C has shown that the red color filter 142R, the green color filter 142G, and the blue color filter 142B may be formed with substantially the same thickness as each other, thicknesses thereof may be adjusted to control color purity of an LCD. In addition, in the third exemplary embodiment as described above, the red color filter 142R is formed first by way of example. However, the formation order of color filters can be changed.

After forming the red color filter 142R, the green color filter 142G, and the blue color filter 142B on the first insulating substrate 110 by the above-described method, the laser beam 430 may be irradiated onto the boundary portions of the red color filter 142R, the green color filter 142G, and the blue color filter 142B, thereby forming the black matrix patterns 120.

As shown in FIG. 6D, the black matrix patterns 120 each having a predetermined width may be formed by irradiating the laser beam 430 onto a plurality of boundary portions of the red color filter 142R, the green color filter 142G, and the blue color filter 142B to cause variations to the compositions of the red color filter 142R, the green color filter 142G, and the blue color filter 142B. The method for forming the black matrix patterns 120 may be substantially the same as the method shown in FIG. 4D. Further, the width of a black matrix pattern 120 according to this exemplary embodiment may be adjusted by controlling a spot size of the laser beam 430 irradiated onto the black matrix patterns 120. For example, the width of a black matrix pattern 120 may be adjusted to about 10 μm to about 40 μm. In addition, in order to optically isolate the red color filter 142R, the green color filter 142G and the blue color filter 142B from each other, a black matrix pattern 120 may be formed thicker than the red color filter 142R, the green color filter 142G and the blue color filter 142B. For example, the thickness of a black matrix pattern 120 may be controlled to about 1 μm to about 5 μm. Since the red color filter 142R, the green color filter 142G and the blue color filter 142B may be first formed on the first insulating substrate 110, and the black matrix patterns 120 are then formed using the laser beam 430, the method according to the exemplary embodiment of the present invention obviates the necessity for photolithography processing equipment to form the black matrix patterns 120, unlike in the prior art.

Accordingly, the number of processing steps, the processing time, and the manufacturing time may be reduced, thereby reducing the manufacturing cost. Similarly, the red color filter 142R, the green color filter 142G and the blue color filter 142B may be formed by the inkjet printing method, suggesting that the photolithography processing equipment may not be necessary.

Next, referring back to FIG. 2, the common electrode 150 may be formed over the first insulating substrate 110 having the red color filter 142R, the green color filter 142G, the blue color filter 142B, and the black matrix patterns 120.

As described above, the common electrode 150 may be formed of a transparent conductive material such as ITO or IZO.

Hereinafter, a method for manufacturing a color filter substrate according to a fourth exemplary embodiment of the present invention will be described with reference to FIG. 7. In FIG. 7, reference numerals refer to like or similar components as in previous figures. Therefore, a detailed description thereof will be omitted or briefly given. FIG. 7 shows a cross-sectional view of a method for manufacturing a color filter substrate according to a fourth exemplary embodiment of the present invention.

First, the red color filter 142R, the green color filter 142G, and the blue color filter 142B may be formed on the first insulating substrate 110 through the processes shown in FIG. 6A, FIG. 6B, and FIG. 6C. Then, referring to FIG. 7, black matrix patterns 120 may be formed by irradiating a laser beam 430′ onto boundary portions of the red color filter 142R, the green color filter 142G, and the blue color filter 142B using a mask 600.

In more detail, the mask 600 having patterns exposing predetermined portions of boundaries of the red color filter 142R, the green color filter 142G, and the blue color filter 142B may be disposed over the red color filter 142R, the green color filter 142G, and the blue color filter 142B. The mask 600 may be divided into a transmissive area 610 and a non-transmissive area 620 to allow a laser beam 430′ to selectively transmit through the mask 600. Therefore, black matrix patterns 120 can be simultaneously formed on a plurality of boundaries of the red color filter 142R, the green color filter 142G, and the blue color filter 142B formed on the first insulating substrate 110.

In the present exemplary embodiment, the focus spot of the laser beam 430′ may be positioned over or under the red color filter 142R, the green color filter 142G, and the blue color filter 142B, to thereby simultaneously irradiate the laser beam 430′ over a relatively wide area.

Here, an irradiation time of the laser beam 430′ applied onto the red color filter 142R, the green color filter 142G, and the blue color filter 142B may vary according to the kind of laser beam used. An excimer laser beam generator, or a similar apparatus, may be used as the laser beam generator.

As described above, the method for manufacturing an LCD and an LCD manufactured thereby according to the present invention may have at least the following advantages.

First, since the photolithography processing equipment for forming black matrix patterns and color filters may not be necessary, the manufacturing cost of a LCD may be reduced.

Second, after forming the color filters, forming the black matrix pattern 20 using a laser beam may decrease the number of processing steps, thus shortening the LCD manufacturing process.

Third, organic black matrix pattern material may not be necessary since the black matrix patterns 120 may be formed by irradiating the boundary portions of the color filter material.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for manufacturing a liquid crystal display (LCD), comprising:
forming red color filters, green color filters, and blue color filters corresponding to pixels on a first insulating substrate; and
forming black matrix patterns at boundary portions of the red color filters, the green color filters, and the blue color filters by irradiating a laser beam onto the boundary portions of the red color filters, the green color filters, and the blue color filters.

2. The method of claim 1, wherein the step of forming black matrix patterns comprises:
irradiating the laser beam while repeatedly moving a predetermined interval in a first direction extending along a first side of a red color filter, a green color filter, or a blue color filter; and
irradiating the laser beam while repeatedly moving a predetermined interval in a second direction extending along a second side of the red color filter, the green color filter, or the blue color filter,
wherein the second side is adjacent to the first side.

3. The method of claim 1, wherein the step of irradiating a laser beam comprises focusing the laser beam along the boundary portions of the red color filters, the green color filters, and the blue color filters.

4. The method of claim 1, wherein the laser beam is a yttrium-aluminum-garnet laser beam or a femto-second laser beam.

5. The method of claim 1, wherein the step of forming black matrix patterns comprises:
positioning a mask over the red color filters, the green color filters, and the blue color filters, the mask having a pattern exposing the boundary portions of the red color filters, the green color filters, and the blue color filters; and
irradiating the laser beam onto a front face of the mask.

6. The method of claim 5, wherein the step of irradiating the laser beam onto a front face of the mask forms black matrix patterns simultaneously at the boundary portions of the red color filters, the green color filters, and the blue color filters by the laser beam transmitted through the mask.

7. The method of claim 5, wherein the laser beam is an excimer laser beam.

8. The method of claim 1, wherein a width of a black matrix pattern is adjusted by controlling a width of a spot size of the laser beam.

9. The method of claim 8, wherein the black matrix pattern is formed to have a width in a range of about 10 μm to about 40 μm.

10. The method of claim 1, further comprising:
forming a common electrode over the red color filter, the green color filter, the blue color filter and the black matrix patterns.

11. The method of claim 1, wherein the step of forming red color filters, green color filters, and blue color filters comprises:
coating an organic photosensitive resin on the first substrate;
soft-baking the organic photosensitive resin;
exposing the organic photosensitive resin; and
developing the organic photosensitive resin.

12. The method of claim 1, wherein the step of forming red color filters, green color filters, and blue color filters comprises:
spraying ink containing a pigment and having a predetermined viscosity.

13. The method of claim 1, wherein the red color filters, the green color filters, and the blue color filters are formed to have substantially the same thickness as each other.

14. The method of claim 1, wherein a black matrix pattern is thicker than a red color filter, a green color filter, and a blue color filter.

15. The method of claim 1, wherein the step of forming black matrix patterns comprises:
forming black matrix patterns to cover gate lines and data lines arranged between pixels on a second insulating substrate.

16. A liquid crystal display (LCD), comprising:
a red color filter, a green color filter, and a blue color filter arranged on a first insulating substrate and corresponding to a pixel region of the LCD; and
black matrix patterns arranged between each color filter, the black matrix patterns comprising irradiated compositions of at least two of the red color filter, the green color filter, and the blue color filter.

17. The LCD of claim 16, wherein a black matrix pattern has a width in a range of about 10 μm to about 40 μm.

18. The LCD of claim 16, wherein a black matrix pattern has a thickness in a range of about 1 μm to about 5 μm.

19. The LCD of claim 16, further comprising:
a second insulating substrate;
a plurality of gate lines arranged on the second insulating substrate to extend substantially parallel to each other in a first direction; and
a plurality of data lines arranged on the second insulating substrate to extend substantially parallel to each other in a second direction, the second direction being substantially perpendicular to the first direction;
wherein the gate lines and the data lines define boundary portions of pixel regions, and the black matrix patterns cover the gate lines and the data lines.
